(19) United States
(12) Patent Application Publication
(10) Pub. No.: US 2025/0065161 A1
(43) Pub. Date: Feb. 27, 2025

(54) SELF-RETRACTING LIFELINE DEVICE

(71) Applicant: CHINHUNG CHEN, Taipei City (TW)

(72) Inventor: CHINHUNG CHEN, Taipei City (TW)

(21) Appl. No.: 18/806,645

(22) Filed: Aug. 15, 2024

(30) Foreign Application Priority Data
Aug. 25, 2023 (TW) 112132050

(51) Int. Cl. A62B 35/00

(52) U.S. Cl. CPC A62B 35/0093

(57) ABSTRACT

A self-retracting lifeline device includes a housing including a suspension ring, opposing, downward extending first and second extensions, and a pivot pivotably disposed through the first and second extensions; a rope seat rotatably disposed on the pivot between the first extension and the second extension, the rope seat including opposing first and second discs, a rope winding drum, and fastening projections; a restoration assembly disposed on the pivot and between the first extension and the rope seat, the restoration assembly including a restoration seat and an elastic member; and an emergency engaging assembly disposed on the pivot and between the second extension and the rope seat, the emergency engaging assembly including an engaging seat, engaging members, two parallel walls, a protrusion, elastic elements, and an engaging ring. In response to a centrifugal force exceeding force exerted by the elastic element, the rotation of the rope seat is stopped.

### FIELD OF THE INVENTION

The invention relates to self-retracting lifeline devices and more particularly to a self-retracting lifeline device having an increased contact area for increasing both a counter-force and a structural strength, an elastic member for stably urging against a fastening projection without slipping, and an increased possibility of emergency engagement to prevent a person working at height from falling.

### BACKGROUND OF THE INVENTION

A conventional self-retracting lifeline device (e.g., Chinese Patent Publication No. CN102946948 or equivalent U.S. Patent Application Publication No. US2011/0315481 A1, entitled “centrifugally-operated apparatus”) is shown in FIGS. 7 and 8. It discloses a pawl 81 having an engaging tooth 811 (or called an engaging edge), a guiding slot 812, and a guide pin 813 in the guiding slot 812.

The pawl 81 may slide outward from a shaft 82 due to excessive centrifugal force. The self-retracting lifeline device may stop immediately when the engaging tooth 811 is stopped by a protrusion 83. As an end, the purpose of preventing a person working at height suspended by the self-retracting lifeline device from falling is achieved.

A compressed helical spring 84 may urge against the shaft 82 to return the pawl 81 to its original position when the blocked state does not exist.

However, the conventional self-retracting lifeline device has the following disadvantages:

The guide pin 813 may break due to excessive force exerted thereon. The guide pin 813 in the guiding slot 812 may limit a movement direction and a movement distance of the pawl 81. Force F1 is generated and transmitted to the guide pin 813 when the engaging tooth 811 is stopped by the protrusion 83. However, the guide pin 813 is small and structurally weak. Thus, the force F1 may break the guide pin 813 and in turn, the self-retracting lifeline device may cause malfunction. The self-retracting lifeline device is designed to prevent a person working at height from falling. Unfortunately, the malfunctioned self-retracting lifeline device may cause the person to fall to death. This is a serious safety issue.

The helical spring 84 tends to slip and is not reliable. The helical spring 84 urges against an arcuate outer surface of the shaft 82. However, this urged position of the helical spring 84 may slip and is not secured.

The single pawl 81 acts slowly and is high risk in operation. The pawl 81 is bulky and only one pawl 81 is provided. The centrifugal force may throw the only pawl 81 outward until the engaging tooth 811 is stopped by the protrusion 83 in case of falling. However, the single pawl 81 acts slowly and thus the risk is high.

Thus, the need for improvement still exists.

### SUMMARY OF THE INVENTION

It is therefore one object of the invention to provide a self-retracting lifeline device having an increased contact area for increasing both a counter-force and a structural strength, an elastic member for stably urging against a fastening projection without slipping, and an increased possibility of emergency engagement to prevent a person working at height from falling. Particularly, the invention aims to solve the problems associated with the conventional art including the guide pin being broken due to excessive force exerted thereon, the helical spring tending to slip from the urged position, the single pawl acting slowly with higher risk in operation.

For achieving above and other objects, the invention provides a self-retracting lifeline device comprising
a housing including a suspension ring; a first extension extending downward from the suspension ring; a second extension extending downward from the suspension ring and opposing the first extension; and a pivot pivotably disposed through the second extension and the first extension;
a rope seat rotatably disposed on the pivot between the extension and the second extension, the rope seat including a first disc having a disc positioning member extending toward the first extension; a second disc opposing the first disc; a rope winding drum formed on an inner surface of the first disc; a plurality of fastening projections formed on an outer surface of the second disc, equally spaced around the pivot, and extending toward the second extension; and a rope storage defined by the first disc, the second disc, and the rope winding drum;
a restoration assembly disposed on the pivot and between the first extension and the rope seat, the restoration assembly including a restoration seat secured to the housing and having a restoration space and a seat positioning member; and an elastic member disposed in the restoration space and having a first fastening end for securing the elastic member to the seat positioning member, and a second fastening end for securing the elastic member to the disc positioning member; and
an emergency engaging assembly disposed on the pivot and between the second extension and the rope seat, the emergency engaging assembly including an engaging seat disposed around the pivot, spaced from the second disc, and being coaxial with the second disc, the engaging seat having a plurality of groove members formed in an inner surface, being radial, and facing the second disc, each of the groove members having two opposite walls; a plurality of engaging members each disposed between the groove member and the second disc and having a central groove with the fastening projection disposed therein, two parallel walls slidably engaged with the parallel walls respectively, and a protrusion; a plurality of elastic elements disposed in the central grooves respectively, each of the elastic elements being biased between the central groove and the fastening projection to push each of the engaging members toward the pivot; and an engaging ring being proximate the second extension, spaced around the engaging seat, and configured to rotate about the engaging seat, the engaging ring having a plurality of protuberances on an inner surface;
wherein in response to rotating the rope seat, the engaging seat rotates and the elastic member is energized; and either in response to stopping the rotation of the rope seat, the energized elastic member releases its energy to rotate the rope seat to its original position; or in response to a centrifugal force exceeding force exerted by at least one of the elastic elements, at least one of the engaging members is thrown toward the engaging ring, and the corresponding protrusion is stopped by at least one of the protuberances, thereby stopping the rotation of the rope seat.

The above and other objects, features and advantages of the invention will become apparent from the following detailed description taken with the accompanying drawings.

### BRIEF DESCRIPTION OF DRAWINGS

FIG. 1A is an exploded view of a self-retracting lifeline device according to a preferred embodiment of the invention;

FIG. 1B is another perspective view of the engaging seat in FIG. 1A;

FIG. 2 is a perspective view of the assembled self-retracting lifeline device;

FIG. 3 is a longitudinal sectional view of the self-retracting lifeline device in FIG. 2;

FIG. 4 is another longitudinal sectional view of the self-retracting lifeline device in FIG. 2 prior to falling;

FIG. 5 is a view similar to FIG. 4 after falling;

FIG. 6A is an exploded perspective view showing the engaging member and the engaging seat to be assembled;

FIG. 6B is a perspective view showing the assembled engaging member and the engaging seat;

FIG. 6C is an elevation view of FIG. 6B;

FIG. 7 is an elevation view of a conventional self-retracting lifeline device; and

FIG. 8 is an exploded view of FIG. 7.

### DETAILED DESCRIPTION OF THE INVENTION

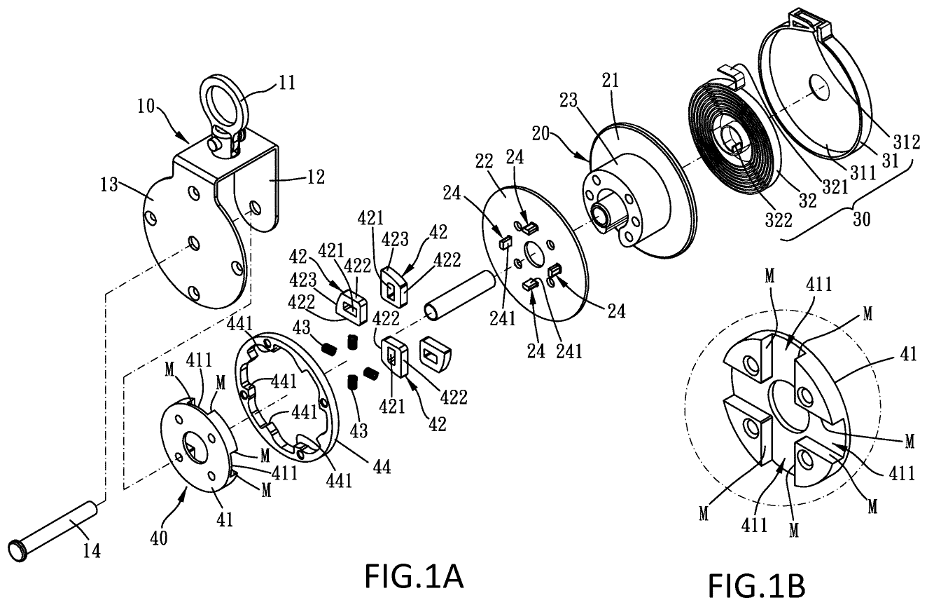

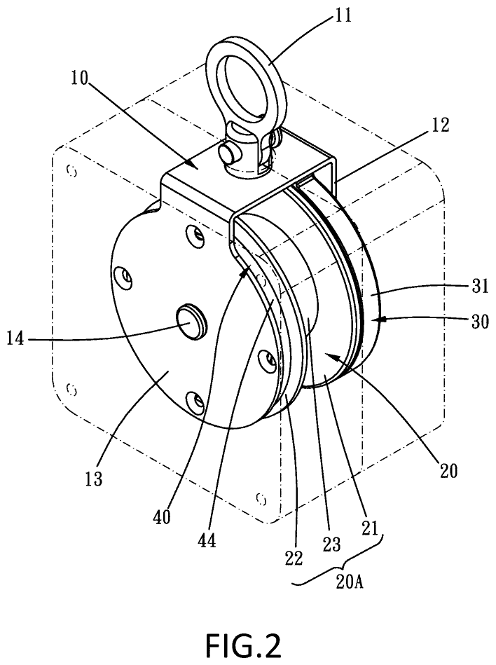

Referring to FIGS. 1A, 1B, 2, 3, 4, 5, 6A, 6B and 6C, a self-retracting lifeline device in accordance with a preferred embodiment of the invention comprises the following components as discussed in detail below.

A housing 10 includes a suspension ring 11, a first extension 12 extending downward from the suspension ring 11, a second extension 13 also extending downward from the suspension ring 11 and opposing the first extension 12, and a pivot 14 pivotably disposed through the second extension 13 and the first extension 12.

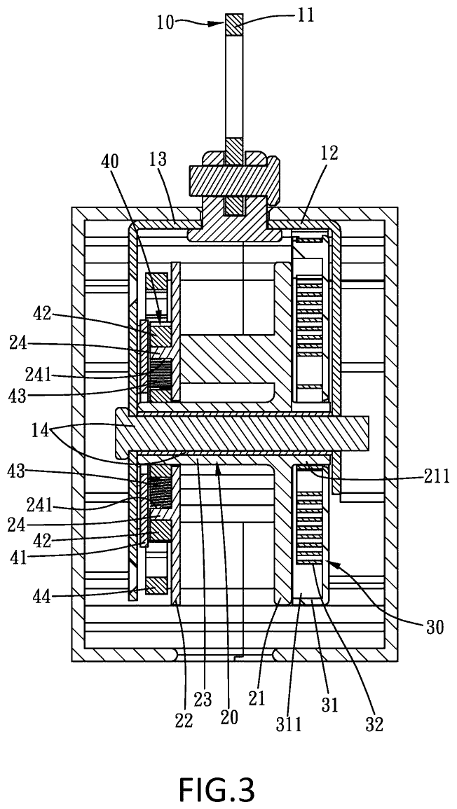

A rope seat 20 is rotatably disposed on the pivot 14 between the extension 12 and the second extension 13. The rope seat 20 includes a first disc 21 having a disc positioning member 211 extending toward the first extension 12 (see FIG. 3), a second disc 22 opposing the first disc 21, a rope winding drum 23 formed on an inner surface of the first disc 21, a plurality of fastening projections 24 formed on an outer surface of the second disc 22, equally spaced around the pivot 14, and extending toward the second extension 13, and a rope storage 20A defined by the first disc 21, the second disc 22, and the rope winding drum 23.

A restoration assembly 30 is disposed on the pivot 14 and between the first extension 12 and the rope seat 20. The restoration assembly 30 includes a restoration seat 31 secured to the housing 10 and having a restoration space 311 and a seat positioning member 312, and a coil spring 32 disposed in the restoration space 311 and having a first fastening end 321 for securing the coil spring 32 to the seat positioning member 312, and a second fastening end 322 for securing the coil spring 32 to the disc positioning member 211.

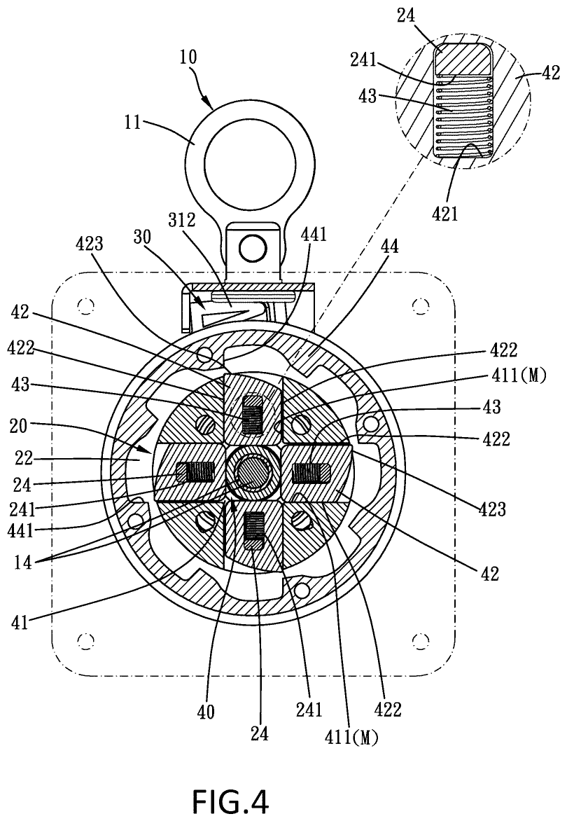

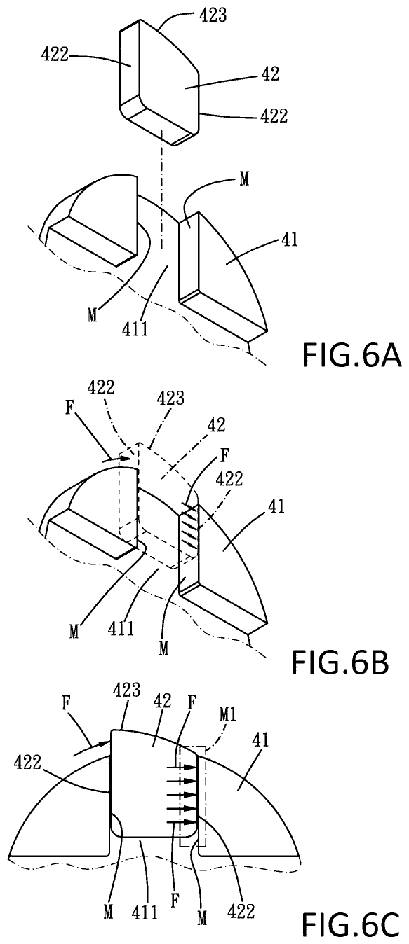

An emergency engaging assembly 40 is disposed on the pivot 14 and between the second extension 12 and the rope seat 20. The emergency engaging assembly 40 includes an engaging seat 41 disposed around the pivot 14, spaced from the second disc 22, and being coaxial with the second disc 22, the engaging seat 41 having a plurality of groove members 411 formed in an inner surface, being radial, and facing the second disc 22 in which each groove member 411 has two opposite walls M (see FIG. 1B); a plurality of engaging members 42 each disposed between the groove member 411 and the second disc 22 and having a central groove 421 with the fastening projection 24 disposed therein, two parallel walls 422 slidably engaged with the parallel walls M respectively (see FIG. 6A) and a protrusion 423; a plurality of torsion springs 43 disposed in the central grooves 421 respectively, each torsion spring 43 being biased between the central groove 421 and the fastening projection 24 (see enlarged portion of FIG. 4) so that each engaging member 42 is pushed toward the pivot 14; and an engaging ring 44 being proximate the second extension 13, spaced around the engaging seat 41, and adapted to rotate about the engaging seat 41, the engaging ring 44 having a plurality of protuberances 441 on an inner surface.

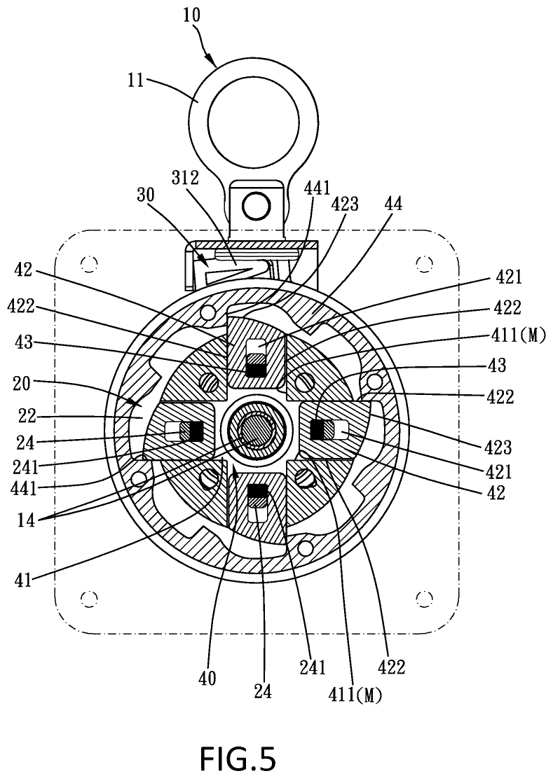

In operation, the rope seat 20 rotates to counterclockwise rotate the engaging seat 41 and the coil spring 32 is energized (see FIG. 4). Next, the rope seat 20 stops rotation. Next, the coil spring 32 releases its energy to rotate the rope seat 20 to its original position. Also, the rope seat 20 rotates to counterclockwise rotate the engaging seat 41 and the coil spring 32 is energized (see FIG. 4) until the centrifugal force exceeds force exerted by at least one torsion spring 43. At least one of the engaging members 42 is (or preferably, all of the engaging members 42 are) thrown toward the engaging ring 44. Thus, the corresponding protrusion 423 is stopped by at least one of the protuberances 441 (see FIG. 5). As a result, the rope seat 20 is stopped immediately, i.e., the self-retracting lifeline device being activated to stop a person working at height and attached to the self-retracting lifeline device from falling.

Preferably, a rope may be wound on the rope winding drum 23 in the rope storage 20A.

Each of the fastening projections 24 has a stop surface 241 (see the enlarged portion of FIG. 5).

Each of the torsion springs 43 is biased between the stop surface 241 and the central groove 421.

The stop surface 241 aims to increase stability of the torsion spring 43 when one end of the torsion spring 43 urges against the stop surface 241 (to reduce slipping effectively).

The coil spring 32 may be replaced by another spring well known in the art.

Characteristics of the invention are detailed below.

In operation, the rope seat 20 rotates to rotate the engaging seat 41 until the centrifugal force exceeds force exerted by at least one torsion spring 43. At least one of the engaging members 42 is (preferably, all of the engaging members 42 are) thrown toward the engaging ring 44. The corresponding protrusion 423 is stopped by at least one of the protuberances 441. As a result, the rope seat 20 is stopped immediately. It is important that only a part of a stopping force exerted by the protuberance 441 is on the protrusion 423 (see FIG. 5). In fact, the stopping force is transmitted from the protrusion 423 to the engaging member 42 as a whole and in turn is transmitted to one of the parallel walls 422. Thus, force is transmitted to the opposite walls M (see a rectangle M1 in FIG. 6C). This wall area is a contact area and acts to counter the force F (see FIGS. 6B and 6C). The increased contact area is stable and greatly increases the structural strength of the protrusion 423. And in turn, a counter-force is increased.

Each of the fastening projections 24 corresponds to the torsion spring 43 and have a stop surface 241. The torsion spring 43 stably urges against the stop surface 241 without slipping.

The number of the engaging members 42 is more than one and the number of the protuberances 441 is more than one. At least one of the engaging members 42 is thrown toward the engaging ring 44 and the corresponding protrusion 423 is stopped by at least one of the protuberances 441, it is sufficient to stop the rope seat 20 immediately. As a result, a possibility of emergency engagement to prevent a person working at height from falling is increased greatly.

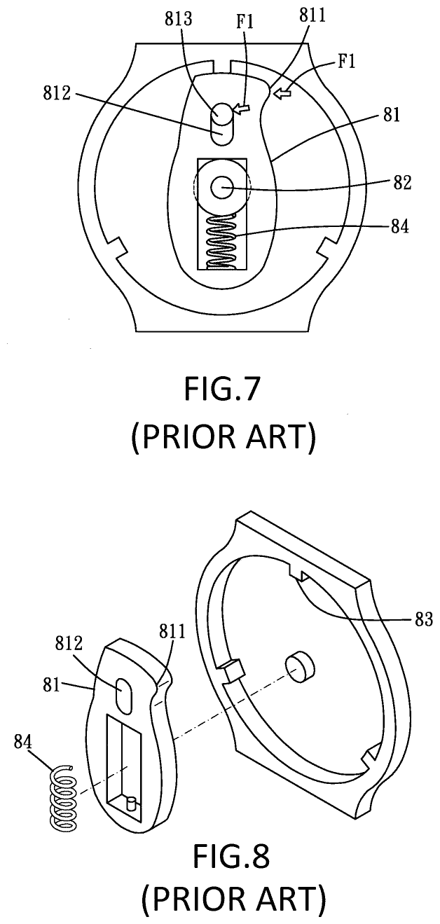

Only one conventional pawl 81 is provided due to its bulkiness (see FIGS. 7 and 8). To the contrary, the engaging members 42 of the invention are smaller and thus there are four engaging members 42 provided. That is, the number of the engaging members 42 is more than one. The possibility of the engaging members 42 stopped by the protuberances 441 is increased due to the increased number of the protuberances 441. Also, both the locking time and the falling time are shortened and thus the striking force is decreased. To the contrary, regarding the conventional centrifugally-operated apparatus only one pawl 81 is provided and the single pawl 81 is required to fulfill the engaging operation. Therefore, the possibility of successfully conducting the engagement is decreased, both the locking time and the falling time are increased, and thus the striking force is increased (i.e., being high risk).

It is concluded that the self-retracting lifeline device of the invention is superior to the conventional centrifugally-operated apparatus.

The invention has the following advantages and benefits in comparison with the conventional art:

Having an increased contact area for increasing both a counter-force and a structural strength. In response to the protrusion 423 being stopped by at least one of the protuberances 441, the stopping force is transmitted from the protrusion 423 to the engaging member 42 as a whole and in turn is transmitted to one of the parallel walls 422. Thus, force is transmitted to the opposite walls M. This wall area is a contact area and acts to counter the force F. The increased contact area is stable and greatly increases the structural strength of the protrusion 423. And in turn, a counter-force is increased. That is why the invention has an increased contact area for increasing both a counter-force and a structural strength.

The torsion spring 43 can stably urge against the fastening projection 24 without slipping. Each of the fastening projections 24 has a stop surface 241 with one end of the torsion spring 43 stably urged against it. There is no slip. Therefore, the torsion spring 43 can stably urge against the fastening projection 24 without slipping.

An increased possibility of emergency engagement to prevent a person working at height from falling. The number of the engaging members 42 is more than one and the number of the protuberances 441 is more than one. At least one of the engaging members 42 is thrown toward the engaging ring 44 and the corresponding protrusion 423 is stopped by at least one of the protuberances 441, it is sufficient to stop the rope seat 20 immediately. As a result, a possibility of emergency engagement to prevent a person working at height from falling is increased.

While the invention has been described in terms of preferred embodiments, those skilled in the art will recognize that the invention can be practiced with modifications within the scope of the appended claims.

What is claimed is:

1. A self-retracting lifeline device, comprising:
a housing including a suspension ring; a first extension extending downward from the suspension ring; a second extension extending downward from the suspension ring and opposing the first extension; and a pivot pivotably disposed through the second extension and the first extension;
a rope seat rotatably disposed on the pivot between the extension and the second extension, the rope seat including a first disc having a disc positioning member extending toward the first extension; a second disc opposing the first disc; a rope winding drum formed on an inner surface of the first disc; a plurality of fastening projections formed on an outer surface of the second disc, equally spaced around the pivot, and extending toward the second extension; and a rope storage defined by the first disc, the second disc, and the rope winding drum;
a restoration assembly disposed on the pivot and between the first extension and the rope seat, the restoration assembly including a restoration seat secured to the housing and having a restoration space and a seat positioning member; and an elastic member disposed in the restoration space and having a first fastening end for securing the elastic member to the seat positioning member, and a second fastening end for securing the elastic member to the disc positioning member; and
an emergency engaging assembly disposed on the pivot and between the second extension and the rope seat, the emergency engaging assembly including an engaging seat disposed around the pivot, spaced from the second disc, and being coaxial with the second disc, the engaging seat having a plurality of groove members formed in an inner surface, being radial, and facing the second disc, each of the groove members having two opposite walls; a plurality of engaging members each disposed between the groove member and the second disc and having a central groove with the fastening projection disposed therein, two parallel walls slidably engaged with the parallel walls respectively, and a protrusion; a plurality of elastic elements disposed in the central grooves respectively, each of the elastic elements being biased between the central groove and the fastening projection to push each of the engaging members toward the pivot; and an engaging ring being proximate the second extension, spaced around the engaging seat, and configured to rotate about the engaging seat, the engaging ring having a plurality of protuberances on an inner surface;
wherein in response to rotating the rope seat, the engaging seat rotates and the elastic member is energized; and either in response to stopping the rotation of the rope seat, the energized elastic member releases its energy to rotate the rope seat to its original position; or in response to a centrifugal force exceeding force exerted by at least one of the elastic elements, at least one of the engaging members is thrown toward the engaging ring, and the corresponding protrusion is stopped by at least one of the protuberances, thereby stopping the rotation of the rope seat.

2. The self-retracting lifeline device of claim 1, wherein the rope winding drum in the rope storage is configured to allow a rope to wind thereon.

3. The self-retracting lifeline device of claim 1, wherein each of the fastening projections has a stop surface, and each of the elastic members is biased between the stop surface and the central groove.

4. The self-retracting lifeline device of claim 1, wherein the elastic member is a coil spring.
